(19) United States
(12) Patent Application Publication
(10) Pub. No.: US 2014/0184036 A1
(43) Pub. Date: Jul. 3, 2014

(54) GOODS STORAGE APPARATUS FOR A VENDING MACHINE

(71) Applicants: HON HAI PRECISION INDUSTRY CO., LTD., New Taipei (TW); HONG FU JIN PRECISION INDUSTRY (WuHan) CO., LTD., Wuhan (CN)

(72) Inventors: YUN-LUNG CHEN, New Taipei (TW); CHUNG CHAI, New Taipei (TW); DA-LONG SUN, Wuhan (CN); YU-GUI CHEN, Wuhan (CN); QIANG LIU, Wuhan (CN)

(73) Assignees: HON HAI PRECISION INDUSTRY CO., LTD., New Taipei (TW); HONG FU JIN PRECISION INDUSTRY (WUHAN) CO., LTD., Wuhan (CN)

(21) Appl. No.: 14/030,015

(22) Filed: Sep. 18, 2013

(30) Foreign Application Priority Data
Dec. 28, 2012 (CN) 2012105826729

(51) Int. Cl. G07F 9/10

(52) U.S. Cl. CPC G07F 9/10
USPC 312/35

(57) ABSTRACT

A goods storage apparatus for a vending machine includes a controlling cabinet and a rack. The controlling cabinet includes a number of controlling devices and a pair of pillars. The pair of pillars defines a number of engaging holes facing each other. The rack accommodates items therein. The rack includes a pair of side walls. The pair of side walls includes a pair of clasps. The pair of clasps engages in the engaging holes to mount the rack between the pair of pillars.

### BACKGROUND

1. Technical Field

The present disclosure generally relates to goods storage apparatuses, and particularly to a goods storage apparatus for a vending machine.

2. Description of Related Art

Vending machines have goods storage apparatuses for accommodating items for sale. However, after all of the items in a goods storage apparatus are bought, new items need to be placed in the goods storage apparatus, which process may be inconvenient. Therefore, a goods storage apparatus that can accommodate a greater quantity of items is needed for vending machines.

Therefore, there is room for improvement within the art.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the embodiments. Moreover, in the drawings, like reference numerals designate corresponding parts throughout the several views.

FIG. 1 is an exploded, isometric view of a goods storage apparatus for a vending machine according to one embodiment.

FIG. 2 is a partial assembled, isometric view of the goods storage apparatus of FIG. 1.

FIGS. 3 is an enlarged view of circled portion III of FIG. 2.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean “at least one.”

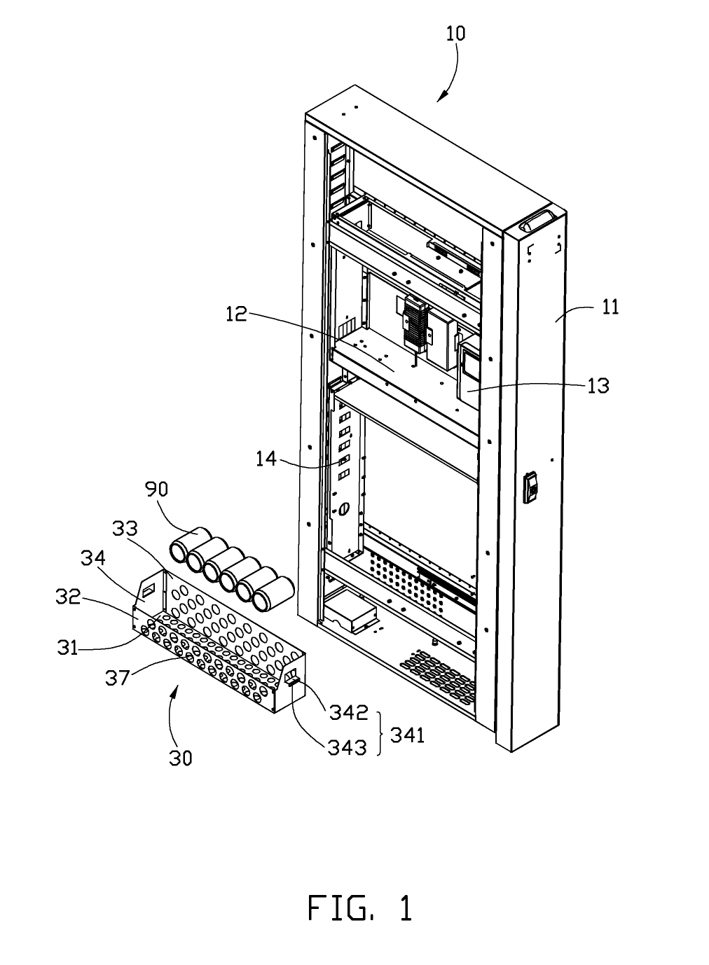

FIG. 1 shows that an embodiment of a goods storage apparatus for a vending machine includes a controlling cabinet 10 and a plurality of racks 30. In the present embodiment, only one rack 30 is shown.

The controlling cabinet 10 includes a pair of parallel pillars 11. A supporting plate 12 is secured between the pair of pillars 11. A plurality of controlling devices 13 of the vending machine is mounted on the supporting plate 12. In one embodiment, the plurality of controlling devices 13 includes a communication module, a motor controlling module, a temperature controlling module, and so on. The communication module is used to exchange data of the vending machine on web. The motor controlling module is used to control motor to rotate to push items. The temperature controlling module is used to control temperature of storing items. Each one of the pair of parallel pillars 11 defines a plurality of engaging holes 14 facing the other pillar 11. The plurality of engaging holes 14 is defined along a length of the pair of parallel pillars 11.

The rack 30 includes a bottom wall 31, a front wall 32, a rear wall 33, and two side walls 34. The front wall 32, the rear wall 33, and the two side walls 34 are connected substantially perpendicularly to edges of the bottom wall 31. The front wall 32 and the rear wall 33 are substantially parallel to each other and face each other. The two side walls 34 are parallel and face each other. The bottom wall 31, the front wall 32, and the rear wall 33 each define a plurality of vent holes 37. Each of the two side walls 34 includes a clasp 341. The clasp 341 includes a connecting portion 342 and an engaging portion 343. The connecting portion 342 is perpendicularly connected to the side wall 34. The connecting portion 342 is parallel to the bottom wall 31. The engaging portion 343 extends downward from a distal side of the connecting portion 342. The engaging portion 343 is parallel to the side wall 34. A distance between the two engaging portions 343 of the two clasps 341 is slightly larger than a distance between the two pillars 11.

A plurality of items 90 is placed in the rack 30. In one embodiment, the plurality of items 90 is beverage cans. A distance between the front wall 32 and the rear wall 33 is equal to a length of the beverage can. Therefore, the plurality of items 90 is stably held in the rack 30.

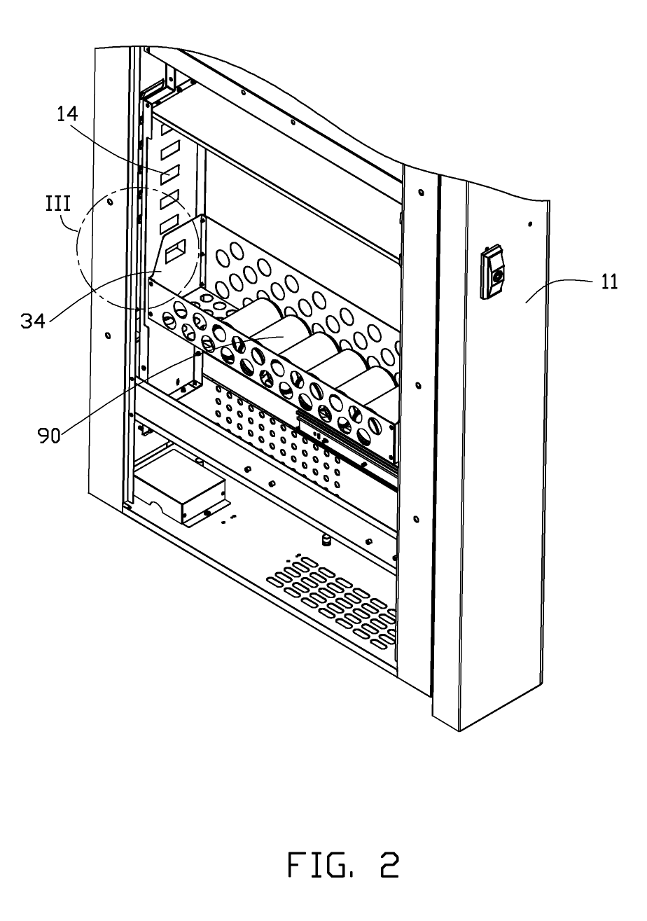

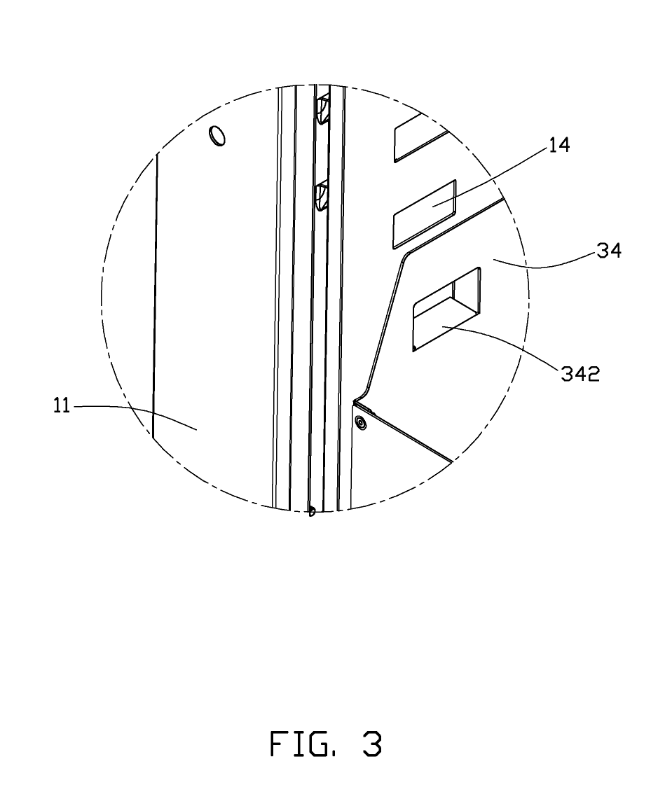

Referring to FIGS. 1 to 3, in assembly, the rack 30 is inclined to raise one side wall 34 and lower another side wall 34. The clasp 341 on the lowered side wall 34 is inserted in one engaging hole 14 of one pillar 11. The raised side wall 34 is moved downwardly to place the rack 30 in a horizontal direction. Simultaneously, the clasp on the raised side wall 34 is inserted in one engaging hole 14 of another pillar 11. The connecting portions 342 of the clasps 341 are located on edges of the corresponding engaging holes 14 of the two pillars 11. Thereby, the rack 30 is mounted on the controlling cabinet 10. Items 90 then can be placed in the rack 30.

In the above embodiment, the two pillars 11 of the controlling cabinet 10 define a plurality of engaging holes 14. Thereby, the plurality of racks 30 can secured between the two pillars 11 simultaneously to accommodate a plurality of items. Because the controlling cabinet 10 can accommodate items, items stored in the vending machine are increased.

It is to be understood, however, that even though numerous characteristics and advantages of the embodiments have been set forth in the foregoing description, together with details of the structure and functions of the embodiments, the disclosure is illustrative only, and changes may be made in detail, especially in the matters of shape, size, and arrangement of parts within the principles of the present disclosure to the full extent indicated by the broad general meaning of the terms in which the appended claims are expressed.

What is claimed is:

1. A goods storage apparatus for a vending machine, comprising:
a controlling cabinet comprising a plurality of controlling devices mounted thereon, and a pair of pillars, the pair of pillars defining a pair of engaging holes; and
a rack configured for accommodating items therein, the rack comprising a pair of side walls, the pair of side walls comprising a pair of clasps; wherein the rack is mounted between the pair of pillars by engaging the pair of clasps in the pair of engaging holes.

2. The goods storage apparatus of claim 1, wherein each of the pair of clasp comprises a connecting portion and an engaging portion, the connecting portion is perpendicularly connected to the corresponding side wall, the engaging portion extends downward from a distal side of the connecting portion, and the engaging portion is parallel to the corresponding side wall.

3. The goods storage apparatus of claim 2, wherein the engaging portion is inserted in the corresponding engaging hole, and the connecting portion is located on an edge of the corresponding engaging hole.

4. The goods storage apparatus of claim 3, wherein a distance between the two engaging portions of the pair of clasps is larger than a distance between the pair of pillars.

5. The goods storage apparatus of claim 1, wherein the rack comprises a bottom wall, and the pair of side walls are connected to opposite edges of the bottom wall.

6. The goods storage apparatus of claim 5, wherein the rack comprises a front wall connected to a front edge of the bottom wall and a rear wall connected to a rear edge of the bottom wall; and the bottom wall, the pair of side walls, the front wall, and the rear wall cooperatively forming a restrictive space.

7. The goods storage apparatus of claim 6, wherein all of the bottom wall, the front wall, and the rear wall define a plurality of vent holes.

8. The goods storage apparatus of claim 1, wherein the plurality of controlling devices comprises a communication module, a motor controlling module, and a temperature controlling module.

9. A goods storage apparatus for a vending machine, comprising:
a controlling cabinet comprising a pair of parallel pillars, a supporting plate secured between the pair of pillars, a plurality of controlling devices mounted on the supporting plate;
a rack configured for accommodating items therein, the rack being mounted between the pair of parallel pillars and located below the plurality of controlling devices.

10. The goods storage apparatus of claim 9, wherein the pair of pillars defines a pair of engaging holes, the rack comprises a pair of side walls, the pair of side walls comprises a pair of clasps, the rack is mounted between the pair of pillars by engaging the pair of clasps in the pair of engaging holes.

11. The goods storage apparatus of claim 10, wherein each of the pair of clasp comprises a connecting portion and an engaging portion, the connecting portion is perpendicularly connected to the corresponding side wall, the engaging portion extends downward from a distal side of the connecting portion, and the engaging portion is parallel to the corresponding side wall.

12. The goods storage apparatus of claim 11, wherein the engaging portion is inserted in the corresponding engaging hole, and the connecting portion is located on an edge of the corresponding engaging hole.

13. The goods storage apparatus of claim 12, wherein a distance between the two engaging portions of the pair of clasps is larger than a distance between the pair of pillars.

14. The goods storage apparatus of claim 10, wherein the rack comprises a bottom wall, and the pair of side walls are connected to opposite edges of the bottom wall.

15. The goods storage apparatus of claim 14, wherein the rack comprises a front wall connected to a front edge of the bottom wall and a rear wall connected to a rear edge of the bottom wall; and the bottom wall, the pair of side walls, the front wall, and the rear wall cooperatively forms a restrictive.

16. The goods storage apparatus of claim 15, wherein all of the bottom wall, the front wall, and the rear wall define a plurality of vent holes.
